(19) United States
(12) Patent Application Publication
(10) Pub. No.: US 2026/0018111 A1
(43) Pub. Date: Jan. 15, 2026

(54) PIXEL COMPENSATION METHOD, DEVICE, AND STORAGE MEDIUM

(71) Applicant: GOERTEK INC., Weifang (CN)

(72) Inventors: Jiahui ZHENG, Weifang (CN); Qiqiang HAN, Weifang (CN); Long JIANG, Weifang (CN); Jianhua LIANG, Weifang (CN); Yingying TANG, Weifang (CN); Yaocheng LIU, Weifang (CN)

(21) Appl. No.: 19/328,361

(22) Filed: Sep. 15, 2025

Related U.S. Application Data
(63) Continuation of application No. PCT/CN2025/098267, filed on May 30, 2025.

(30) Foreign Application Priority Data
Jul. 12, 2024 (CN) 202410932213.1

(51) Int. Cl. G09G 3/32; G09G 3/20

(52) U.S. Cl. CPC G09G 3/32; G09G 3/2074; G09G 2320/0223; G09G 2320/0233; G09G 2320/0242

(57) ABSTRACT

The present application provides a pixel compensation method, a device and a storage medium, which relates to the technical field of display, including: determining a sub-pixel ratio of a target sub-pixel in a corresponding target pixel, and determining an average load value of an entire screen; determining a compensation value mapping relationship applicable to the target sub-pixel according to a preset ratio interval of the sub-pixel ratio; determining a sub-pixel parameter of the target sub-pixel and a target compensation value corresponding to the average load value according to the compensation value mapping relationship; and performing a compensation operation for the target sub-pixel based on the target compensation value.

### CROSS-REFERENCE TO RELATED APPLICATIONS

The present application is a continuation application of International Application No. PCT/CN2025/098267, filed on May 30, 2025, which claims priority to Chinese Patent Application No. 202410932213.1, entitled in “PIXEL COMPENSATION METHOD, DEVICE, AND STORAGE MEDIUM” and filed on Jul. 12, 2024. The disclosures of the above-mentioned applications are incorporated herein by reference in their entireties.

### TECHNICAL FIELD

The present application relates to the technical field of display, and in particular to a pixel compensation method, a device and a storage medium.

### BACKGROUND

Dynamic IR Drop (Electric Current Resistance Drop) refers to the phenomenon that when the local content of the picture frame changes in the display device, the voltage of the changed local area changes, causing the current of the unchanged area to change accordingly, thereby affecting the brightness, chromaticity and other properties of the unchanged area.

In order to reduce the impact of dynamic IR Drop, the display screen is usually adjusted by pixel compensation to maintain the consistency of display brightness and color.

However, for some new screens, such as micro organic light-emitting diode (OLED) display screens, due to the particularity of the manufacturing process, the single-channel sub-pixels and non-single-channel sub-pixels have large differences in display brightness under the same display parameters. If the same compensation value is simply applied to single-channel sub-pixels and non-single-channel sub-pixels, due to the different display performances of the two, the problem of inconsistent screen brightness and color will occur.

The above content is only used to assist in understanding the technical solution of the present application, and does not mean that the above content is recognized as related art.

### SUMMARY

The main purpose of the present application is to provide a pixel compensation method, a device and a storage medium, aiming to solve the technical problem of inconsistent screen brightness and color.

To achieve the above purpose, the present application proposes a pixel compensation method, including:

determining a sub-pixel ratio of a target sub-pixel in a corresponding target pixel, and determining an average load value of an entire screen;

determining a compensation value mapping relationship applicable to the target sub-pixel according to a preset ratio interval of the sub-pixel ratio;

determining a sub-pixel parameter of the target sub-pixel and a target compensation value corresponding to the average load value according to the compensation value mapping relationship; and

performing a compensation operation for the target sub-pixel based on the target compensation value.

In an embodiment, the compensation value mapping relationship includes a hybrid dynamic lookup table and/or a single dynamic lookup table; and the determining the compensation value mapping relationship applicable to the target sub-pixel according to the preset ratio interval of the sub-pixel ratio includes:

in response to that the sub-pixel ratio is less than or equal to a first preset threshold, then determining the compensation value mapping relationship applicable to the target sub-pixel to be the hybrid dynamic lookup table;

in response to that the sub-pixel ratio is greater than or equal to a second preset threshold, then determining the compensation value mapping relationship applicable to the target sub-pixel to be the single dynamic lookup table; and

in response to that the sub-pixel ratio is greater than the first preset threshold and less than the second preset threshold, then determining the compensation value mapping relationship applicable to the target sub-pixel to be the hybrid dynamic lookup table and the single dynamic lookup table; the first preset threshold is less than the second preset threshold.

In an embodiment, the determining the sub-pixel parameter of the target sub-pixel and the target compensation value corresponding to the average load value according to the compensation value mapping relationship includes:

determining an ordinate index corresponding to the sub-pixel parameter according to the compensation value mapping relationship;

determining an abscissa index corresponding to the average load value according to the compensation value mapping relationship; and

obtaining the target compensation value of the target sub-pixel according to the ordinate index and the abscissa index.

In an embodiment, the compensation value mapping relationship includes a hybrid dynamic lookup table and a single dynamic lookup table; the determining the sub-pixel parameter of the target sub-pixel and the target compensation value corresponding to the average load value according to the compensation value mapping relationship includes:

determining a first intermediate compensation value corresponding to the sub-pixel parameter of the target sub-pixel and the average load value according to the hybrid dynamic lookup table;

determining a second intermediate compensation value corresponding to the sub-pixel parameter of the target sub-pixel and the average load value according to the single dynamic lookup table;

obtaining a weight value corresponding to the first intermediate compensation value and the second intermediate compensation value; and

determining a weighted sum of the first intermediate compensation value and the second intermediate compensation value based on the weight value, and configuring the weighted sum as the target compensation value.

In an embodiment, the obtaining the weight value corresponding to the first intermediate compensation value and the second intermediate compensation value includes:

determining the weight value corresponding to the first intermediate compensation value and the second intermediate compensation value according to the sub-pixel ratio, the first preset threshold and the second preset threshold.

In an embodiment, the determining the sub-pixel ratio of the target sub-pixel in the corresponding target pixel includes any one of the following:

configuring a ratio of a grayscale value of the target sub-pixel to a grayscale value corresponding to the target pixel as the sub-pixel ratio;

configuring a ratio of a brightness value of the target sub-pixel to a brightness value corresponding to the target pixel as the sub-pixel ratio;

configuring a ratio of a load value of the target sub-pixel to a load value corresponding to the target pixel as the sub-pixel ratio; and

configuring a ratio of a measured current value of the target sub-pixel to a measured current value corresponding to the target pixel as the sub-pixel ratio.

In an embodiment, the determining the average load value of the entire screen includes:

obtaining a screen resolution and a current value of each sub-pixel;

determining a total load value of the screen according to the current value of the sub-pixel; and

determining the average load value of the entire screen according to the total load value of the screen and the screen resolution.

In an embodiment, the determining the average load value of the entire screen includes any one of the following:

obtaining an average grayscale value of the screen, and determining the average load value of the entire screen according to a preset mapping relationship between the average grayscale value of the screen and the average load value; and

obtaining grayscale values of all sub-pixels, and determine the load values of all the sub-pixels according to the preset mapping relationship between the grayscale value and the load value, and average the load values of all the sub-pixels to obtain the average load value.

In addition, to achieve the above-mentioned purpose, the present application also proposes a pixel compensation device, including:

a memory;

a processor; and

a computer program stored in the memory and executable on the processor;

the computer program is configured to implement the steps of the pixel compensation method.

In addition, to achieve the above purpose, the present application also proposes a storage medium; the storage medium is a computer-readable storage medium;

the storage medium stores a computer program; and

when the computer program is executed by the processor, the steps of the pixel compensation method are implemented.

The present application provides a pixel compensation method, which determines the applicable compensation value mapping relationship according to the preset ratio interval of the sub-pixel ratio of the target sub-pixel. Since the compensation value mapping relationship is customized according to the characteristics and display performance of the sub-pixels in the interval, the compensation value mapping relationship can more accurately reflect the compensation requirements of the target sub-pixel. Then, by searching for the corresponding input value in the compensation value mapping relationship, the compensation value for the target sub-pixel can be obtained. This compensation value is specially customized for the target sub-pixel, so it can more accurately correct its display deviation. Through the above steps, this solution uses different compensation values for sub-pixels of different display structures, thereby effectively avoiding the problem of inaccurate brightness and color after compensation caused by a unified compensation value, and significantly improving the display performance of the entire screen.

### BRIEF DESCRIPTION OF THE DRAWINGS

The drawings herein are incorporated into the specification and constitute a part of the specification, showing embodiments that conform to the present application, and together with the specification, are used to explain the principles of the present application.

In order to more clearly illustrate the technical solutions in the embodiments of the present application or the related art, the drawings required for use in the embodiments or the related art description will be briefly introduced below. Obviously, for those skilled in the art, other drawings can be obtained based on these drawings without creative labor.

FIG. 1 is a schematic diagram of a simplified flowchart of a pixel compensation method of the present application.

FIG. 2 is a schematic diagram of a flowchart of the pixel compensation method according to a first embodiment of the present application.

FIG. 3 is a schematic diagram of a flowchart of the pixel compensation method according to the first embodiment of the present application.

FIG. 4 is a schematic diagram of a flowchart of the pixel compensation method according to the first embodiment of the present application.

FIG. 5 is a schematic diagram of a flowchart of the pixel compensation method according to the first embodiment of the present application.

FIG. 6 is a schematic diagram of a flowchart of the pixel compensation method according to the first embodiment of the present application.

FIG. 7 is a schematic diagram of a hybrid dynamic lookup table of the pixel compensation method according to the first embodiment of the present application.

FIG. 8 is a schematic diagram of a single dynamic lookup table of the pixel compensation method according to the first embodiment of the present application.

FIG. 9 is a schematic diagram of a flowchart of the pixel compensation method according to a second embodiment of the present application.

FIG. 10 is a schematic diagram of a flowchart of the pixel compensation method according to a third embodiment of the present application.

FIG. 11 is a schematic diagram of a flowchart of the pixel compensation method according to a fourth embodiment of the present application.

FIG. 12 is a schematic diagram of the effect of the pixel compensation method of the present application.

FIG. 13 is a schematic diagram of the device structure of the hardware operating environment involved in the pixel compensation method according to an embodiment of the present application.

The purpose, functional features and advantages of the present application will be further explained in conjunction with the embodiments and with reference to the accompanying drawings.

### DETAILED DESCRIPTION OF THE EMBODIMENTS

It should be understood that the specific embodiments described herein are only used to explain the technical solution of the present application and are not used to limit the present application.

In order to better understand the technical solution of the present application, the following will be described in detail in conjunction with the drawings of the specification and the specific implementation methods.

The main solution of the embodiment of the present application is: according to the preset ratio interval of the sub-pixel ratio of the target sub-pixel, determining the compensation value mapping relationship applicable to the target sub-pixel; and then inputting the sub-pixel parameter of the target sub-pixel and the average load value into the above compensation value mapping relationship, so as to obtain the target compensation value of the target sub-pixel, and then complete the compensation operation.

The types of screens of devices are gradually diversified, such as traditional display screens such as liquid crystal display (LCD), active-matrix organic light-emitting diode (AMOLED), and new display screens such as Micro OLED.

In the display screen, there are single-channel sub-pixels and non-single-channel sub-pixels:

It is known that a pixel is usually composed of three channels: red R, green G, and blue B, and each channel has a sub-pixel to represent the brightness or intensity of the color.

When a pixel has only one non-zero sub-pixel value in the RGB three channels, then the non-zero sub-pixel is called a single-channel sub-pixel. For example, in a pixel, if the sub-pixel value of the R channel is 255, and the sub-pixel values of the G channel and the B channel are both 0, then the R sub-pixel is a single-channel sub-pixel.

If a pixel has two or three non-zero sub-pixel values in the RGB three channels, then all non-zero sub-pixels in the pixel are called non-single-channel sub-pixels. For example, in a pixel, if the sub-pixel value of the R channel is 255, the sub-pixel value of the G channel is 128, and the sub-pixel value of the B channel is 100, then the R sub-pixel, G sub-pixel, and B sub-pixel in the pixel are all non-single-channel sub-pixels.

In particular, the traditional display screen and the new display screen differ in terms of dynamic IR Drop performance, mainly manifested in that, due to the particularity of the pixel circuit design and the light-emitting device, the brightness difference between the single-channel sub-pixel and the non-single-channel sub-pixel in the new display screen is much greater than the brightness difference between the single-channel sub-pixel and the non-single-channel sub-pixel in the traditional display screen when the screen load and grayscale value are the same.

If the same compensation value is simply applied to the single-channel sub-pixel and the non-single-channel sub-pixel, the screen brightness and color will not be uniform due to the different display performances of the two. Therefore, a more accurate algorithm is needed to calculate the compensation value of each pixel.

To solve the above problem, the present application adopts a scheme of calculating the compensation value sub-pixel by sub-pixel. Referring to FIG. 1, the sub-pixel ratio of the target sub-pixel is calculated, and the compensation value mapping relationship suitable for the target sub-pixel is determined in a targeted manner according to the interval in which it is located. Then, the sub-pixel parameters and the average load value are input into the compensation value mapping relationship, and a suitable target compensation value can be obtained. In this way, different compensation values can be provided for different types of sub-pixels, so that they can be compensated from different display brightness to a uniform display brightness.

It should be noted that the execution subject of this embodiment can be a computing service device with data processing, network communication and program running functions, such as a tablet computer, a personal computer, a mobile phone, etc., or a pixel compensation device capable of realizing the above functions. The following takes the pixel compensation device as an example to illustrate this embodiment and the following embodiments.

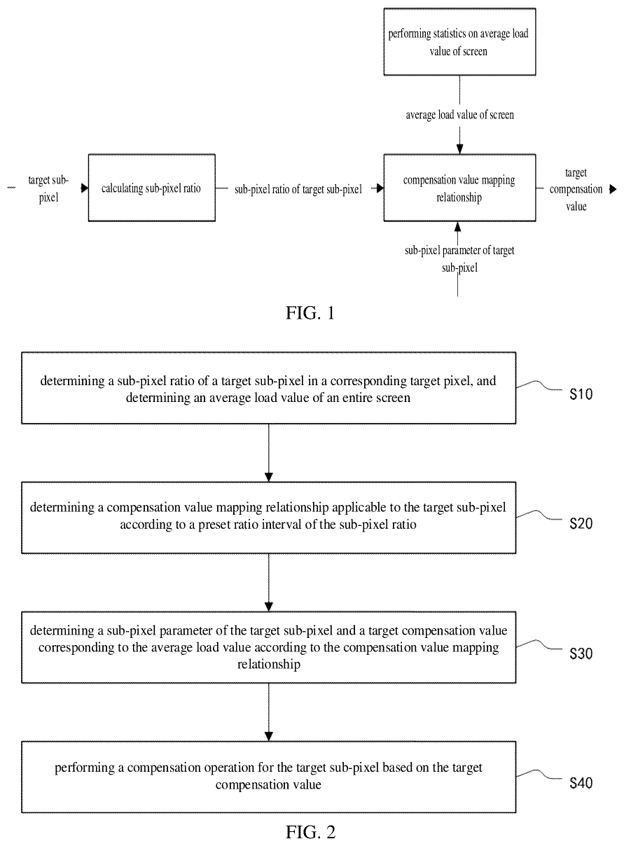

Based on this, the embodiment of the present application provides a pixel compensation method, referring to FIG. 2, which is a flow chart of the first embodiment of the pixel compensation method of the present application.

In this embodiment, the pixel compensation method includes steps S10 to S40:

Step S10, determining the sub-pixel ratio of the target sub-pixel in the corresponding target pixel, and determining the average load value of the entire screen;

It should be noted that a pixel is the basic unit constituting a digital image, and a sub-pixel is a component of a pixel, which is the smallest unit for displaying a single color. For example, in an RGB display, a pixel is composed of three sub-pixels, corresponding to red R, green G and blue B respectively.

In a feasible implementation, the step of determining the sub-pixel ratio of the target sub-pixel in the corresponding target pixel includes any one of A10 to A40:

Step A10, taking the ratio of the grayscale value of the target sub-pixel to the grayscale value corresponding to the target pixel as the sub-pixel ratio;

Step A20, taking the ratio of the brightness value of the target sub-pixel to the brightness value corresponding to the target pixel as the sub-pixel ratio;

Step A30, taking the ratio of the load value of the target sub-pixel to the load value corresponding to the target pixel as the sub-pixel ratio;

Step A40, taking the ratio of the measured current value of the target sub-pixel to the measured current value corresponding to the target pixel as the sub-pixel ratio.

It should be noted that sub-pixel parameters generally refer to specific values associated with each color channel in a pixel, including but not limited to grayscale value, brightness value, load value and measured current value. Among them, the grayscale value is used to represent the color depth or grayscale level of the pixel, which can be represented by an integer between 0 and 255, where 0 represents black, 255 represents white, and the intermediate value represents different degrees of gray; the brightness value is used to represent the brightness of the sub-pixel in the image, which can be represented by an integer between 0 and 255, where 0 represents no brightness and 255 represents the highest brightness; the load value is the rated value associated with the sub-pixel, such as the rated current value, which belongs to the specified theoretical value and is used to represent the design parameters of the device or component; the measured current value is the current magnitude passing through the sub-pixel directly obtained by the measuring device, which is used to represent the actual situation of the device or component.

Optionally, based on the grayscale value or color channel value of the adjacent pixel, an interpolation algorithm such as linear interpolation or bilinear interpolation is used to obtain the grayscale value and/or brightness value of the sub-pixel; or, the load value of the sub-pixel is obtained by consulting the specification parameters or data sheet of the device or component; or, the measured current value displayed by the measuring device is read.

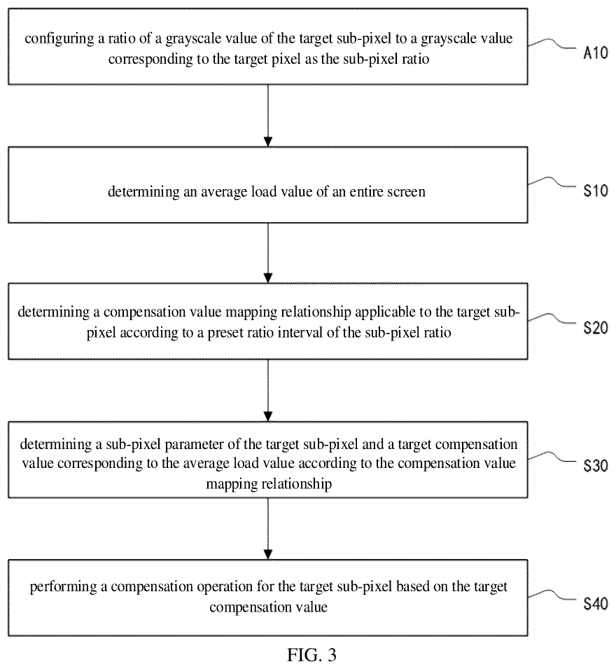

Exemplarily, referring to FIG. 3, based on the above principle, the grayscale value of the target sub-pixel is obtained, and the grayscale value of the other two sub-pixels is divided, and the above data is summarized to obtain the grayscale value corresponding to the target pixel.

Further, the ratio of the grayscale value of the target sub-pixel to the grayscale value corresponding to the target pixel is calculated to obtain the sub-pixel ratio of the target sub-pixel.

Exemplarily, assuming that the target sub-pixel refers to the sub-pixel of the R channel, then the calculation is performed according to the following formula:

$$R\_ratio = \frac{R\_grey \_level}{R\_grey \_level + G\_grey \_level + B\_grey \_level}$$

Where, R_ratio is the grayscale value ratio of the target sub-pixel, R_grey_level is the grayscale value of the target sub-pixel, G_grey_level and B_grey_level are the grayscale values of other sub-pixels, and the denominator is the total grayscale value.

It can be seen that when the target sub-pixel is a single-channel sub-pixel, its calculated ratio is 1; and when the grayscale values of the three-channel sub-pixels in the pixel are equal, the ratio of the sub-pixel of a certain channel should be 0.33.

It can be understood that by considering the ratio calculation of different dimensions, this solution can improve the accuracy and adaptability of the calculation, which helps to better reflect the real ratio relationship of the target sub-pixel in the target pixel, thereby improving the quality of the image processing results.

In another feasible implementation, the specific area where the target sub-pixel is located can be a square centered on the target sub-pixel, such as selecting a 5×5 or 7×7 pixel area as the specific area. The sub-pixel ratio of the feature area is determined and it is used as the sub-pixel ratio of the target sub-pixel.

The average load value of the screen is an indicator to measure the overall power consumption of the screen, and this value can be used to evaluate the load level of the display device.

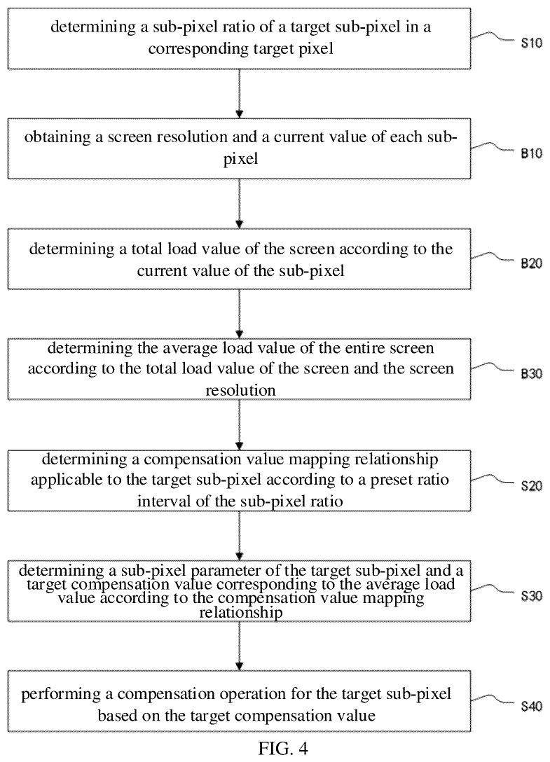

In a feasible implementation, referring to FIG. 4, the step of determining the average load value of the entire screen includes B10˜B30:

Step B10, obtaining the screen resolution and the current value of each sub-pixel;

Step B20, determining the total load value of the screen according to the current value of the sub-pixel;

Step B30, determining the average load value of the entire screen according to the total load value of the screen and the screen resolution.

Screen resolution refers to the number of pixels displayed horizontally and vertically on the screen, usually expressed in the form of “horizontal×vertical”. In technical implementation, it can be obtained by querying the hardware information of the display device or the interface provided by the operating system.

It is known that the current value is a physical quantity that describes the flow of electrons. In display technology, it is directly related to the power consumption of the screen. Higher current means brighter display brightness and higher display power consumption. In technical implementation, the current value of a single sub-pixel can be determined based on the measuring device, and then the sum of the current values of all R channel sub-pixels, G channel sub-pixels and B channel sub-pixels are counted, and the total load value of the screen is obtained by summing up.

Finally, the screen resolution is divided by the screen load value to obtain the average load value of the entire screen.

The specific formula is as follows:

$$I\_R = {\sum }_{j = 0}^{h} {\sum }_{i = 0}^{w} {I\_R}_{i , j}$$

$$I\_G = {\sum }_{j = 0}^{h} {\sum }_{i = 0}^{w} {I\_G}_{i , j}$$

$$I\_B = {\sum }_{j = 0}^{h} {\sum }_{i = 0}^{w} {I\_B}_{i , j}$$

$$avg\_loading = \frac{I\_R + I\_G + I\_B}{w * h}$$

Where h is the vertical resolution of the screen, w is the horizontal resolution of the screen, I R is the sum of the currents of all R channel sub-pixels in the displayed image, I_G is the sum of the currents of all G channel sub-pixels in the displayed image, I_B is the sum of the currents of all B channel sub-pixels in the displayed image, and avg loading is the average load value of the screen.

It can be understood that this solution directly focuses on the current consumption of each pixel on the screen, avoiding the simple average calculation of the current value of the entire system, thereby more accurately reflecting the actual load condition of the screen, and thus accurately calculating the load value of the entire screen.

In another feasible implementation, the step of determining the average load value of the entire screen includes C10 or C20:

Step C10, obtaining the average grayscale value of the screen, and determining the average load value of the entire screen according to the preset mapping relationship between the average grayscale value of the screen and the average load value;

When the maximum brightness that the screen can display is determined, the brightness of the screen is usually determined by the grayscale value; that is, the higher the grayscale value, the higher the brightness of the screen. The brightness of the screen directly affects the display power consumption of the screen, because higher brightness usually requires more energy supply. Therefore, there is an obvious correlation between the grayscale value and energy consumption of the screen; that is, when the maximum brightness that the screen can display is determined, the higher the grayscale value, the greater the display power consumption.

By conducting experiments and data analysis in advance, the load values corresponding to different grayscale values are modeled and recorded. This mapping relationship can be linear, nonlinear or defined by an empirical formula.

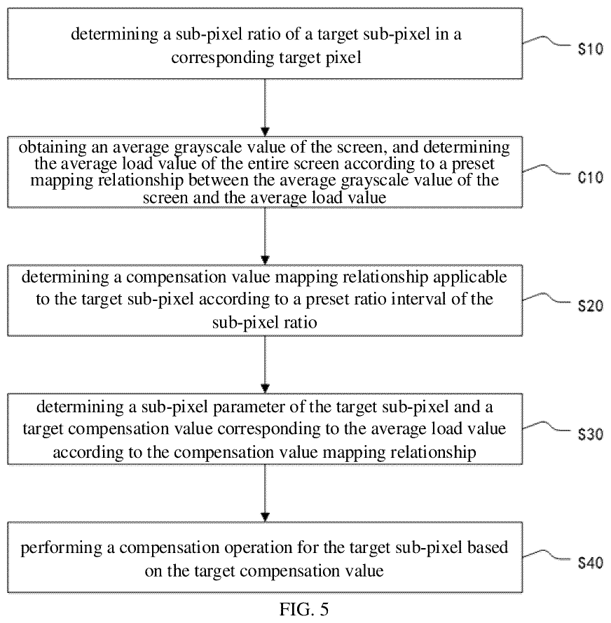

Referring to FIG. 5, each pixel in the grayscale image is first traversed by image processing technology or a screen driver, and its grayscale values are added up, and then divided by the total number of pixels to obtain the average grayscale value of the screen.

Furthermore, by using the preset mapping relationship between the average grayscale value of the screen and the average load value of the screen, the corresponding average load value can be determined according to the average grayscale value of the entire screen.

Step C20, obtaining the grayscale values of all sub-pixels, determining the load values of all the sub-pixels according to the preset mapping relationship between the grayscale value and the load value, and averaging the load values of all the sub-pixels to obtain the average load value of the screen.

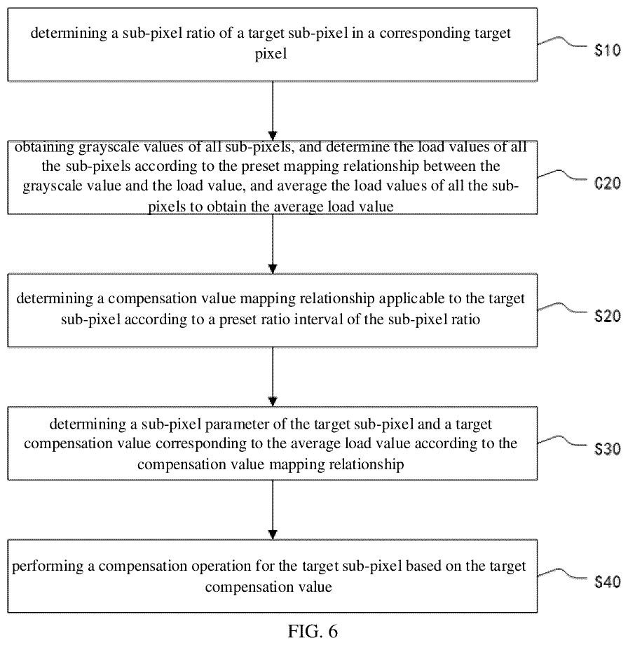

Referring to FIG. 6, each sub-pixel is traversed to obtain the corresponding grayscale value; the load value of each sub-pixel is determined based on the preset mapping relationship between the grayscale value and the load value; all the load values are added and the average is taken, and the average load value of the screen can be obtained.

It can be understood that this solution directly derives the load value according to the grayscale value through the preset mapping relationship, which is simple and fast, does not require real-time monitoring data and complex calculations, and reduces the complexity of implementation.

In addition, a specific area in the screen can also be selected, such as selecting a 5×5 or 7×7 central pixel area as a specific area. The average load value of the feature area is determined and it is used as the average load value of the entire screen.

The above are only several feasible implementations of step S10 provided in this embodiment, and this embodiment does not specifically limit the specific implementation of step S10.

Step S20, according to the preset ratio interval where the sub-pixel ratio is located, determining the compensation value mapping relationship applicable to the target sub-pixel;

It should be noted that the compensation value mapping relationship is used to store the compensation value of a specific sub-pixel under different average screen loads, which is specifically expressed as a dynamic look-up table (DLUT) or other data structure. For ease of understanding, DLUT will be used for explanation in the following.

It can be understood that the display performance of non-single-channel sub-pixels and single-channel sub-pixels is different, that is, a sub-pixel has the same sub-pixel value, but when it belongs to a non-single-channel sub-pixel and a single-channel sub-pixel, its displayed brightness and color are not the same. Therefore, this solution corresponds to setting mixed look-up table (mix DLUT) and single look-up table (sig DLUT). The table stores the compensation values corresponding to several specific sub-pixel parameters under several specific screen average loads. The ordinate of the table corresponds to the sub-pixel parameter, and the abscissa corresponds to the average load value of the screen; the sub-pixel parameter can be a grayscale value.

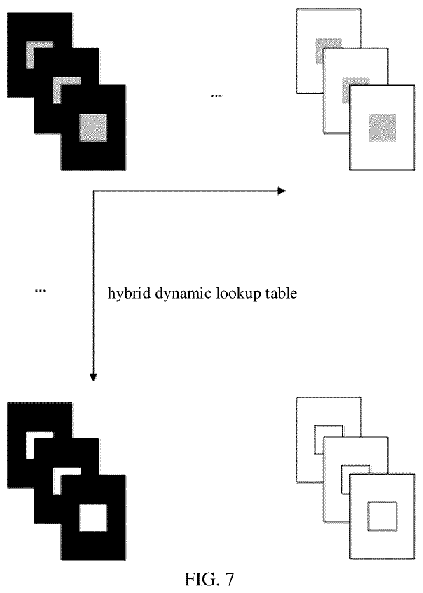

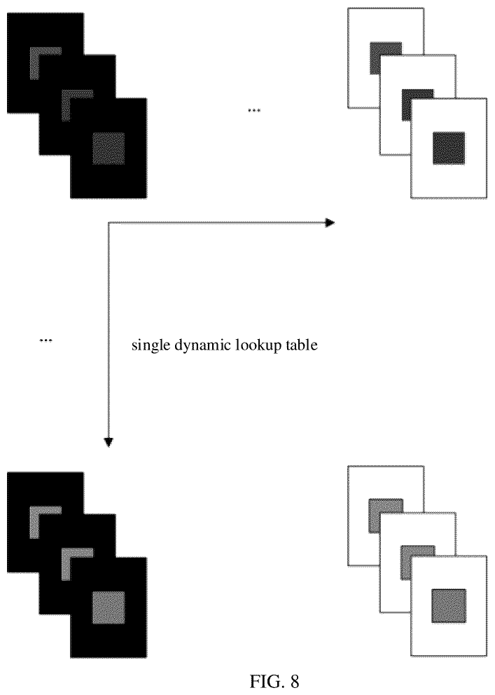

FIG. 7 is a mix DLUT, which stores the compensation amount required for the pixel value when the brightness corresponding to a non-single-channel sub-pixel is adjusted to the target brightness; FIG. 8 is a sig DLUT, which stores the compensation amount required for the pixel value when the brightness corresponding to a single-channel sub-pixel is adjusted to the target brightness. Among them, the pictures corresponding to the four corners are the measurement pictures required to construct the DLUT.

Optionally, two or more intervals are set, and each interval is associated with different compensation rules, or different dynamic lookup tables are used, or different calculation methods are used.

For example, a threshold is set to distinguish two intervals. Assuming that the threshold is 0.5, when the sub-pixel ratio is in the first interval [0, 0.5], the compensation value mapping relationship is determined to be mix DLUT; when the sub-pixel ratio is in the second interval [0.5, 1], the compensation value mapping relationship is determined to be sig DLUT.

Step S30, according to the compensation value mapping relationship, determining the target compensation value corresponding to the sub-pixel parameter of the target sub-pixel and the average load value;

Optionally, the sub-pixel parameter and the average load value are used as input, and the compensation value mapping relationship is searched. The system compares the difference between the input parameter and the existing parameter in the lookup table to find the closest match. Once the match is found, the system takes out the corresponding compensation value as the output result.

Step S40, based on the target compensation value, performing the compensation operation for the target sub-pixel.

For the target sub-pixel, corresponding adjustments are made according to the compensation value, such as adjusting its grayscale value. Specifically, different degrees of adjustment can be made through three channels to achieve the adjustment of the brightness and color of the entire pixel.

This embodiment provides a pixel compensation method; according to the preset ratio interval where the sub-pixel ratio of the target sub-pixel is located, the compensation value mapping relationship applicable to the target sub-pixel is determined; and then the sub-pixel parameter and the average load value of the target sub-pixel are inputted into the above compensation value mapping relationship, so as to obtain the compensation value of the target sub-pixel, and then complete the compensation operation.

This embodiment provides a pixel compensation method. The applicable compensation value mapping relationship is determined according to the preset ratio interval of the sub-pixel ratio of the target sub-pixel. Since the compensation value mapping relationship is customized according to the characteristics and display performance of the sub-pixel in the interval, the compensation value mapping relationship can more accurately reflect the compensation requirements of the target sub-pixel. Then, by searching for the corresponding input value in the compensation value mapping relationship, the compensation value for the target sub-pixel can be obtained. This compensation value is specially customized for the target sub-pixel, so it can more accurately correct its display deviation. Through the above steps, this scheme uses different compensation values for sub-pixels of different display structures, thereby effectively avoiding the problem of inaccurate brightness and color after compensation caused by a unified compensation value, and significantly improving the display performance of the entire screen.

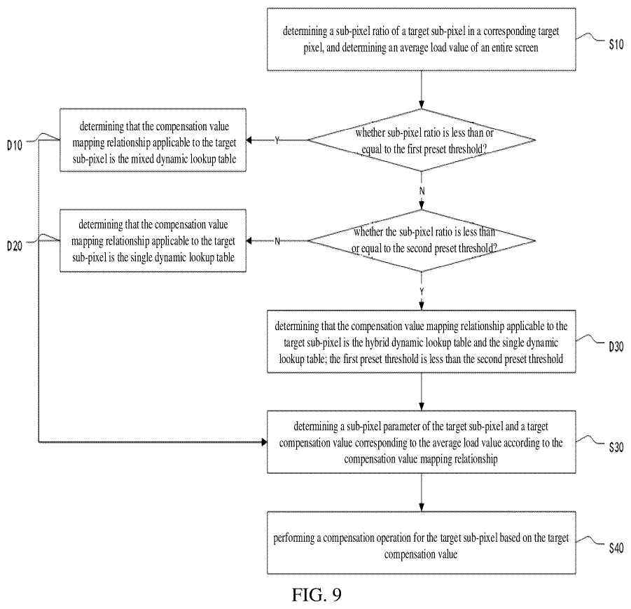

Based on the first embodiment of the present application, in the second embodiment of the present application, the same or similar content as the above first embodiment can be referred to the above introduction, and will not be repeated later. On this basis, please refer to FIG. 9, step S20 includes steps D10˜D30:

Step D10, if the sub-pixel ratio is less than or equal to the first preset threshold, then determining that the compensation value mapping relationship applicable to the target sub-pixel is the hybrid dynamic lookup table;

Step D20, if the sub-pixel ratio is greater than or equal to the second preset threshold, then determining that the compensation value mapping relationship applicable to the target sub-pixel is the single dynamic lookup table;

Step D30, if the sub-pixel ratio is greater than the first preset threshold and less than the second preset threshold, then determining that the compensation value mapping relationship applicable to the target sub-pixel is the hybrid dynamic lookup table and the single dynamic lookup table; the first preset threshold is less than the second preset threshold.

It should be noted that the preset threshold is a threshold preset according to the characteristics of the display technology and design requirements, and is used to distinguish different sub-pixel ratio ranges. The value of the first preset threshold thr1 is such as 0.33, and the value of the second preset threshold thr2 is such as 1.

If the sub-pixel ratio is less than or equal to the first preset threshold, that is, the sub-pixel ratio is very small, which means that the sub-pixels of a certain color in the image are very rare. In this case, it means that the sub-pixel ratio of other channels may be large. Affected by the physical structure of the new screen, the brightness of the sub-pixel is greatly affected by the mutual influence between channels, so the hybrid dynamic lookup table mix DLUT can be used for more efficient processing.

If the sub-pixel ratio is greater than or equal to the second preset threshold, that is, the sub-pixel ratio is large, which means that the sub-pixel of this color is dominant in the image. In this case, therefore, the use of a single dynamic lookup table sig DLUT can be used for more accurate and efficient processing of this dominant type of sub-pixel to achieve better visual effects.

If the sub-pixel ratio is greater than the first preset threshold and less than the second preset threshold, in this case, the use of a mixed or single dynamic lookup table alone may not achieve the best effect. Therefore, the use of a hybrid dynamic lookup table mix DLUT and a single dynamic lookup table sig DLUT at the same time can balance the needs of different sub-pixel types and achieve more comprehensive image processing.

The present embodiment provides a pixel compensation method, which can better process different areas and colors in an image by selecting a suitable dynamic lookup table according to the sub-pixel ratio. Specifically, when the sub-pixel ratio is low, the sub-pixels are more affected by the mutual influence between channels, and the use of a hybrid dynamic lookup table can more accurately compensate for the brightness and color errors in this case; when the sub-pixel ratio is high, the sub-pixels are relatively weakly affected by the mutual influence between channels, and the use of a single dynamic lookup table can more accurately compensate for the brightness and color errors in this case; when the sub-pixel ratio is moderate, both the hybrid dynamic lookup table and the single dynamic lookup table are applicable, supporting a smooth transition of the compensation results between single-channel sub-pixels and non-single-channel sub-pixels, so that two sub-pixels with similar brightness will not have a brightness gap after compensation because they belong to different channel classifications.

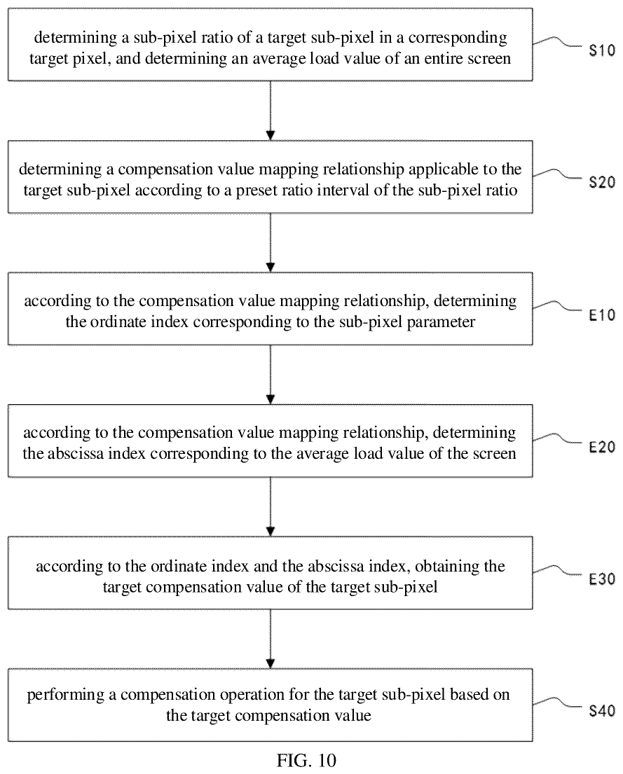

Based on the first embodiment of the present application, in the third embodiment of the present application, the same or similar contents as those in the above-mentioned first embodiment can be referred to the above introduction, and will not be repeated later. On this basis, please refer to FIG. 10, step S30 includes steps E10˜E30:

Step E10, according to the compensation value mapping relationship, determining the ordinate index corresponding to the sub-pixel parameter;

Step E20, according to the compensation value mapping relationship, determining the abscissa index corresponding to the average load value of the screen;

Step E30, according to the ordinate index and the abscissa index, obtaining the target compensation value of the target sub-pixel.

On the one hand, the sub-pixel parameter describes the current state or attribute of the sub-pixel. Substituting it into the compensation value mapping relationship, the corresponding ordinate index can be obtained. This index value mainly focuses on the display characteristics of the sub-pixel itself, and can be used to adjust the brightness, color, etc. of the sub-pixel to compensate for the display unevenness caused by physical aging, manufacturing errors, etc.

On the other hand, the average load value of the screen reflects the overall usage of the screen. Substituting it into the compensation value mapping relationship, the corresponding horizontal coordinate index can be obtained. This index value mainly focuses on the overall current intensity of the screen and can be used to adjust the display state of the sub-pixel to match the overall display effect of the screen.

Finally, according to the horizontal and vertical coordinate index values, the interpolation position of the sub-pixel point in the lookup table can be obtained. The compensation value of the sub-pixel is obtained by interpolation calculation from the lookup table according to the interpolation position. This compensation value takes into account the display characteristics of the sub-pixel itself and the overall current intensity of the screen at the same time to achieve more accurate display adjustment.

This embodiment provides a pixel compensation method. By using the horizontal and vertical coordinate index values, the interpolation position can be determined; and combining the data of the lookup table, the compensation value of the sub-pixel can be accurately calculated, thereby making the display adjustment more accurate.

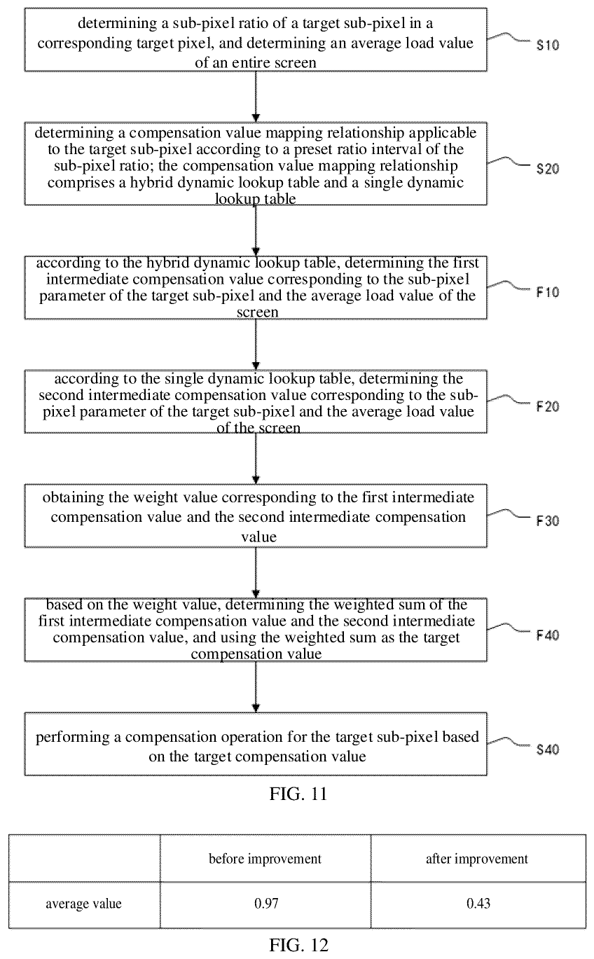

Based on the first embodiment of the present application, in the fourth embodiment of the present application, the same or similar content as the above-mentioned first embodiment can refer to the above introduction, and will not be repeated later. On this basis, please refer to FIG. 11, step S30 includes steps F10˜F40:

Step F10, according to the hybrid dynamic lookup table, determining the first intermediate compensation value corresponding to the sub-pixel parameter of the target sub-pixel and the average load value of the screen;

Step F20, according to the single dynamic lookup table, determining the second intermediate compensation value corresponding to the sub-pixel parameter of the target sub-pixel and the average load value of the screen;

Step F30, obtaining the weight value corresponding to the first intermediate compensation value and the second intermediate compensation value;

Step F40, based on the weight value, determining the weighted sum of the first intermediate compensation value and the second intermediate compensation value, and using the weighted sum as the target compensation value.

When the target sub-pixel is applicable to the hybrid dynamic lookup table, the target compensation value is determined in the following manner. The specific manner can be referred to the third embodiment and will not be repeated here:

Substituting the target channel parameter and the average load value into the hybrid dynamic lookup table to find the compensation value comp_mix, and outputting the value as the final result comp_res:

comp_res=comp_mix

When the target sub-pixel is applicable to the single dynamic lookup table, the target compensation value is determined in the following manner:

Substituting the target channel parameter and the average load value into the single dynamic lookup table to find the compensation value comp_sig, and outputting the value as the final result comp_res:

comp_res=comp_sig

When the target sub-pixel is applicable to the hybrid dynamic lookup table and the single dynamic lookup table, the target compensation value is calculated in the following manner:

Substituting the target channel parameter and the average load value into the hybrid dynamic lookup table to obtain the first intermediate compensation value comp_mix, and substituting the target channel parameter and the average load value into the single dynamic lookup table to obtain the second intermediate compensation value comp_sig.

Further, the weight values corresponding to the first intermediate compensation value and the second intermediate compensation value are obtained. This weight value can be a fixed value or calculated based on the current data. This embodiment does not make specific limitations.

Exemplarily, the weight values corresponding to the first intermediate compensation value and the second intermediate compensation value are both 0.5; then the weighted sum of the first intermediate compensation value and the second intermediate compensation value is (0.5*first intermediate compensation value+0.5*second intermediate compensation value), which is the target compensation value.

Exemplarily, according to the sub-pixel ratio, the first preset threshold and the second preset threshold, the weight values corresponding to the first intermediate compensation value and the second intermediate compensation value are determined, and then the target compensation value is calculated. The specific formula is as follows:

$$comp\_res = \frac{( pix\_ratio - thr 1 ) * comp\_sig + ( thr 2 - pix\_ratio ) * comp\_mix}{thr 2 - thr 1}$$

Where, comp_res is the target compensation value; pix_ratio is the sub-pixel ratio; thr1 is the first preset threshold; thr2 is the second preset threshold; comp_mix is the first intermediate compensation value, and comp_sig is the second intermediate compensation value.

It can be understood that as the data is updated and changed, the weight value calculated based on the current data can be automatically adjusted accordingly, so that the final target compensation value is more in line with the actual situation.

From the above content, it can be seen that under the same screen load, the same sub-pixel value will get different compensation values when it has different pixel ratios.

This embodiment provides a pixel compensation method. The hybrid dynamic lookup table may contain more scenes and factors, while the single dynamic lookup table may more accurately compensate pixels in certain specific situations. When the ratio of sub-pixels is moderate, by using these two lookup tables in coordination, a balance can be found between accuracy and comprehensiveness, and their advantages can be fully utilized.

It should be noted that the above examples are only used to understand the present application and do not constitute a limitation on the pixel compensation method of the present application. More forms of simple transformations based on this technical concept are all within the protection scope of the present application.

Referring to FIG. 12, the average value of the DeltaE2000 measurement data in the 24-color card is applied to the processing method of adding different compensation values for single-channel and non-single-channel sub-pixels described in the present application and the scheme without adding the processing method.

It can be seen from the data that the improved IR Drop compensation according to the present application has a better effect, that is, higher brightness and color consistency.

The present application provides a pixel compensation device, and the pixel compensation device includes: at least one processor; and a memory connected to the at least one processor in communication; the memory stores instructions that can be executed by at least one processor, and the instructions are executed by at least one processor, so that at least one processor can execute the pixel compensation method in the above first embodiment.

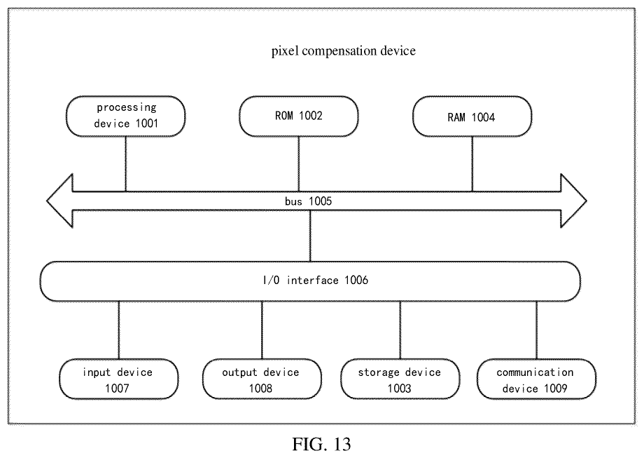

Referring to FIG. 13 below, a schematic diagram of the structure of a pixel compensation device suitable for implementing an embodiment of the present application is shown. The pixel compensation device in the embodiment of the present application may include, but is not limited to, mobile terminals such as mobile phones, laptop computers, digital broadcast receivers, personal digital assistant (PDA), portable application description (PAD), portable media player (PMP), vehicle-mounted terminals (such as vehicle-mounted navigation terminals), etc., and fixed terminals such as digital TVs, desktop computers, etc. The pixel compensation device shown in FIG. 13 is only an example and should not impose any restrictions on the functions and scope of use of the embodiment of the present application.

As shown in FIG. 13, the pixel compensation device may include a processing device 1001 (such as a central processing unit, a graphics processor, etc.), which may perform various appropriate actions and processes according to a program stored in a read-only memory (ROM) 1002 or a program loaded from a storage device 1003 to a random access memory (RAM) 1004. Various programs and data required for the operation of the pixel compensation device are also stored in RAM 1004. The processing device 1001, the ROM 1002, and the RAM 1004 are connected to each other via a bus 1005. An input/output (I/O) interface 1006 is also connected to the bus. Typically, the following systems may be connected to the I/O interface 1006: an input device 1007 including, for example, a touch screen, a touch pad, a keyboard, a mouse, an image sensor, a microphone, an accelerometer, a gyroscope, etc.; an output device 1008 including, for example, a liquid crystal display (LCD), a speaker, a vibrator, etc.; a storage device 1003 including, for example, a magnetic tape, a hard disk, etc.; and a communication device 1009. The communication device 1009 may allow the pixel compensation device to communicate wirelessly or wired with other devices to exchange data. Although the figure shows a pixel compensation device with various systems, it should be understood that it is not required to implement or have all the systems shown. More or fewer systems may be implemented or composed alternatively.

In an embodiment, according to the embodiments disclosed in the present application, the process described above with reference to the flowchart can be implemented as a computer software program. For example, the embodiments disclosed in the present application include a computer program product, which includes a computer program carried on a computer-readable medium, and the computer program contains program code for executing the method shown in the flowchart. In such an embodiment, the computer program can be downloaded and installed from the network through a communication device, or installed from a storage device 1003, or installed from a ROM 1002. When the computer program is executed by the processing device 1001, the above functions defined in the method of the embodiment disclosed in the present application are executed.

The pixel compensation device provided in the present application adopts the pixel compensation method in the above embodiment to solve the technical problem of inconsistent screen brightness and color. Compared with the related art, the beneficial effects of the pixel compensation device provided in the present application are the same as the beneficial effects of the pixel compensation method provided in the above embodiment, and the other technical features in the pixel compensation device are the same as the features disclosed in the method of the previous embodiment, which will not be repeated here.

It should be understood that the various parts disclosed in the present application can be implemented in hardware, software, firmware or a combination thereof. In the description of the above embodiments, specific features, structures, materials or characteristics can be combined in any one or more embodiments or examples in a suitable manner.

The above is only a specific embodiment of the present application, but the protection scope of the present application is not limited thereto. Those skilled in the art can easily think of changes or replacements within the technical scope disclosed in the present application, which should be covered within the protection scope of the present application. Therefore, the protection scope of the present application shall be subject to the protection scope of the claims.

The present application provides a computer-readable storage medium having computer-readable program instructions (i.e., computer programs) stored thereon, and the computer-readable program instructions are used to execute the pixel compensation method in the above embodiments.

The computer-readable storage medium provided in the present application can be, for example, a USB flash drive, but is not limited to electrical, magnetic, optical, electromagnetic, infrared, or semiconductor systems, systems or devices, or any combination thereof. More specific examples of computer-readable storage media may include, but are not limited to: electrical connections with one or more wires, portable computer disks, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above. In this embodiment, the computer-readable storage medium may be any tangible medium containing or storing a program that may be used by or in conjunction with an instruction execution system, system, or device. The program code contained on the computer-readable storage medium may be transmitted using any suitable medium, including but not limited to: wires, optical cables, radio frequency (RF), etc., or any suitable combination of the above.

The above-mentioned computer-readable storage medium may be contained in the pixel compensation device; or it may exist alone without being assembled into the pixel compensation device.

The computer-readable storage medium carries one or more programs. When the one or more programs are executed by the pixel compensation device, the pixel compensation device: determines the sub-pixel ratio of the target sub-pixel in the corresponding target pixel, and determines the average load value of the entire screen; determines the compensation value mapping relationship applicable to the target sub-pixel according to the preset ratio interval of the sub-pixel ratio; determines the sub-pixel parameter of the target sub-pixel and the target compensation value corresponding to the average load value according to the compensation value mapping relationship; performs the compensation operation for the target sub-pixel based on the target compensation value.

The computer program code for performing the operation of the present application can be written in one or more programming languages or a combination thereof, and the programming languages include object-oriented programming languages such as Java, Smalltalk, C++, and conventional procedural programming languages such as “C” language or similar programming languages. The program code can be executed completely on the user's computer, partially on the user's computer, as an independent software package, partially on the user's computer and partially on a remote computer, or completely on a remote computer or server. In case of involving a remote computer, the remote computer may be connected to the user computer through any type of network, including a local area network (LAN) or a wide area network (WAN), or may be connected to an external computer (e.g., through the Internet using an Internet service provider).

The flowcharts and block diagrams in the accompanying drawings illustrate the possible architecture, functions, and operations of the systems, methods, and computer program products according to various embodiments of the present application. In this regard, each box in the flowchart or block diagram may represent a module, a program segment, or a portion of a code, which contains one or more executable instructions for implementing a specified logical function. It should also be noted that, in some alternative implementations, the functions marked in the box may also occur in an order different from that marked in the accompanying drawings. For example, two boxes represented in succession may actually be executed substantially in parallel, and they may sometimes be executed in reverse order, depending on the functions involved. It should also be noted that each box in the block diagram and/or flowchart, and the combination of boxes in the block diagram and/or flowchart, can be implemented by a dedicated hardware-based system that performs the specified function or operation, or can be implemented by a combination of dedicated hardware and computer instructions.

The modules involved in the embodiments described in the present application can be implemented by software or by hardware. Among them, the name of the module does not constitute a limitation on the unit itself under certain circumstances.

The readable storage medium provided in the present application is a computer-readable storage medium, and the computer-readable storage medium stores computer-readable program instructions (i.e., computer programs) for executing the above-mentioned pixel compensation method, which can solve the technical problem of inconsistent screen brightness and color. Compared with the related art, the beneficial effects of the computer-readable storage medium provided in the present application are the same as the beneficial effects of the pixel compensation method provided in the above-mentioned embodiment, and will not be repeated here.

The above descriptions are only some embodiments of the present application, and does not limit the patent scope of the present application. All equivalent structural transformations made by using the contents of the present application specification and drawings under the technical concept of the present application, or directly/indirectly applied in other related technical fields, are included in the patent protection scope of the present application.

What is claimed is:

1. A pixel compensation method, comprising:
determining a sub-pixel ratio of a target sub-pixel in a corresponding target pixel, and determining an average load value of an entire screen;
determining a compensation value mapping relationship applicable to the target sub-pixel according to a preset ratio interval of the sub-pixel ratio;
determining a sub-pixel parameter of the target sub-pixel and a target compensation value corresponding to the average load value according to the compensation value mapping relationship; and
performing a compensation operation for the target sub-pixel based on the target compensation value.

2. The method according to claim 1, wherein the compensation value mapping relationship comprises a hybrid dynamic lookup table and/or a single dynamic lookup table; and the determining the compensation value mapping relationship applicable to the target sub-pixel according to the preset ratio interval of the sub-pixel ratio comprises:
in response to that the sub-pixel ratio is less than or equal to a first preset threshold, then determining the compensation value mapping relationship applicable to the target sub-pixel to be the hybrid dynamic lookup table;
in response to that the sub-pixel ratio is greater than or equal to a second preset threshold, then determining the compensation value mapping relationship applicable to the target sub-pixel to be the single dynamic lookup table; and
in response to that the sub-pixel ratio is greater than the first preset threshold and less than the second preset threshold, then determining the compensation value mapping relationship applicable to the target sub-pixel to be the hybrid dynamic lookup table and the single dynamic lookup table, wherein the first preset threshold is less than the second preset threshold.

3. The method according to claim 1, wherein the determining the sub-pixel parameter of the target sub-pixel and the target compensation value corresponding to the average load value according to the compensation value mapping relationship comprises:
determining an ordinate index corresponding to the sub-pixel parameter according to the compensation value mapping relationship;
determining an abscissa index corresponding to the average load value according to the compensation value mapping relationship; and
obtaining the target compensation value of the target sub-pixel according to the ordinate index and the abscissa index.

4. The method according to claim 1, wherein the compensation value mapping relationship comprises a hybrid dynamic lookup table and a single dynamic lookup table; the determining the sub-pixel parameter of the target sub-pixel and the target compensation value corresponding to the average load value according to the compensation value mapping relationship comprises:
determining a first intermediate compensation value corresponding to the sub-pixel parameter of the target sub-pixel and the average load value according to the hybrid dynamic lookup table;
determining a second intermediate compensation value corresponding to the sub-pixel parameter of the target sub-pixel and the average load value according to the single dynamic lookup table;
obtaining a weight value corresponding to the first intermediate compensation value and the second intermediate compensation value; and
determining a weighted sum of the first intermediate compensation value and the second intermediate compensation value based on the weight value, and configuring the weighted sum as the target compensation value.

5. The method according to claim 4, wherein the obtaining the weight value corresponding to the first intermediate compensation value and the second intermediate compensation value comprises:
determining the weight value corresponding to the first intermediate compensation value and the second intermediate compensation value according to the sub-pixel ratio, the first preset threshold and the second preset threshold.

6. The method according to claim 1, wherein the determining the sub-pixel ratio of the target sub-pixel in the corresponding target pixel comprises any one of the following:
configuring a ratio of a grayscale value of the target sub-pixel to a grayscale value corresponding to the target pixel as the sub-pixel ratio;
configuring a ratio of a brightness value of the target sub-pixel to a brightness value corresponding to the target pixel as the sub-pixel ratio;
configuring a ratio of a load value of the target sub-pixel to a load value corresponding to the target pixel as the sub-pixel ratio; and
configuring a ratio of a measured current value of the target sub-pixel to a measured current value corresponding to the target pixel as the sub-pixel ratio.

7. The method according to claim 1, wherein the determining the average load value of the entire screen comprises:
obtaining a screen resolution and a current value of each sub-pixel;
determining a total load value of the screen according to the current value of the sub-pixel; and
determining the average load value of the entire screen according to the total load value of the screen and the screen resolution.

8. The method according to claim 1, wherein the determining the average load value of the entire screen comprises any one of the following:
obtaining an average grayscale value of the screen, and determining the average load value of the entire screen according to a preset mapping relationship between the average grayscale value of the screen and the average load value; and
obtaining grayscale values of all sub-pixels, and determine the load values of all the sub-pixels according to the preset mapping relationship between the grayscale value and the load value, and average the load values of all the sub-pixels to obtain the average load value.

9. A pixel compensation device, comprising:
a memory;
a processor, and
a computer program stored in the memory and executable on the processor;
wherein the computer program is configured to implement the steps of the pixel compensation method according to claim 1.

10. A storage medium, wherein the storage medium is a computer-readable storage medium;
the storage medium stores a computer program; and
when the computer program is executed by the processor, the steps of the pixel compensation method according to claim 1 are implemented.
